(19) United States
(12) Patent Application Publication
(10) Pub. No.: US 2026/0318218 A1
(43) Pub. Date: Oct. 15, 2026

(54) TIP CLEARANCE CONTROL FOR TURBINE ENGINE ROTOR

(71) Applicant: RTX Corporation, Farmington, CT (US)

(72) Inventors: Murat Yazici, Glastonbury, CT (US); Thomas E. Clark, Wells, ME (US)

(21) Appl. No.: 19/176,911

(22) Filed: Apr. 11, 2025

(51) Int. Cl. F01D 11/24

(52) U.S. Cl. CPC F01D 11/24; F05D 2220/323; F05D 2260/201

(57) ABSTRACT

A method is provided for operating a turbine engine. During this method, a bladed turbine rotor is rotated about an axis. A turbine shroud is next to and circumscribes the bladed turbine rotor. A clearance is controlled between the bladed turbine rotor and the turbine shroud using a clearance control system. Operation of the clearance control system is tuned during turbine engine operation based on a change in an engine operating parameter over a period of time.

### BACKGROUND OF THE DISCLOSURE

### 1. Technical Field

This disclosure relates generally to an aircraft and, more particularly, to tip clearance control for an engine rotor of an aircraft propulsion system.

### 2. Background Information

An aircraft propulsion system may include an active clearance control system for controlling tip clearance between an engine rotor and a surrounding rotor shroud. Various types and configurations of clearance control systems are known in the art. While these known clearance control systems have various benefits, there is still room in the art for improvement.

### SUMMARY OF THE DISCLOSURE

According to an aspect of the present disclosure, a method is provided for operating a turbine engine. During this method, a bladed turbine rotor is rotated about an axis. A turbine shroud is next to and circumscribes the bladed turbine rotor. A clearance is controlled between the bladed turbine rotor and the turbine shroud using a clearance control system. Operation of the clearance control system is tuned during turbine engine operation based on a change in an engine operating parameter over a period of time.

According to another aspect of the present disclosure, another method is provided for operating a turbine engine. During this method, a bladed turbine rotor is rotated about an axis. A turbine shroud is next to and circumscribes the bladed turbine rotor. A clearance is controlled between the bladed turbine rotor and the turbine shroud using a clearance control system. Operation of the clearance control system is changed over a period of time to reduce leakage between the bladed turbine rotor and the turbine shroud as the bladed turbine rotor and/or the turbine shroud degrades.

According to still another aspect of the present disclosure, another method is provided for operating a turbine engine. During this method, a bladed turbine rotor is rotated about an axis. The bladed turbine rotor includes a plurality of turbine blades arranged circumferentially about the axis in an array. A turbine shroud is next to and circumscribes the array of the plurality of turbine blades. A clearance is controlled between the bladed turbine rotor and the turbine shroud using a clearance control system. Operation of the clearance control system is tuned over a period of time to account for: material worn away from the turbine shroud over the period of time; and/or material worn away from the array of the plurality of turbine blades over the period of time.

The operation of the clearance control system may be tuned over the period of time based on an increase in a combustion products temperature over the period of time compared to a predicted combustion products temperature over the period of time.

The operation of the clearance control system may be changed over the period of time based on a change in an engine operating parameter over the period of time.

The clearance control system may also be operated to reduce ovalization of a turbine casing supporting the turbine shroud.

The operation of the clearance control system may be tuned over the period of time to reduce leakage between the bladed turbine rotor and the turbine shroud as the bladed turbine rotor and/or the turbine shroud degrades over the period of time.

The operation of the clearance control system may be tuned over the period of time to account for material worn away from the turbine shroud over the period of time.

The bladed turbine rotor may include a plurality of turbine blades. The operation of the clearance control system may be tuned over the period of time to account for material worn away from the plurality of turbine blades over the period of time.

The engine operating parameter may be indicative of a combustion products temperature at an exhaust section of the turbine engine.

The engine operating parameter may be indicative of a combustion products temperature at a turbine section of the turbine engine.

The bladed turbine rotor may be disposed in a high pressure turbine section of the turbine engine.

The bladed turbine rotor may be disposed in a low pressure turbine section of the turbine engine.

The method may also include: rotating a second bladed turbine rotor about the axis, wherein a second turbine shroud is next to and circumscribes the second bladed turbine rotor; and controlling a clearance between the second bladed turbine rotor and the second turbine shroud using the clearance control system.

The operation of the clearance control system may be tuned independently for the controlling of the clearance between the bladed turbine rotor and the turbine shroud and the controlling of the clearance between the second bladed turbine rotor and the second turbine shroud.

The clearance control system may be configured to control the clearance between the bladed turbine rotor and the turbine shroud by impinging air against and/or flowing the air along a turbine casing supporting the turbine shroud.

The clearance control system may be configured to cool the turbine casing with the air substantially uniformly around the axis.

The clearance control system may be configured to cool the turbine casing with the air asymmetrically around the axis.

The turbine engine may be part of an aircraft propulsion system with a ducted propulsor rotor.

The turbine engine may be part of an aircraft propulsion system with an open propulsor rotor.

The present disclosure may include any one or more of the individual features disclosed above and/or below alone or in any combination thereof.

The foregoing features and the operation of the invention will become more apparent in light of the following description and the accompanying drawings.

### BRIEF DESCRIPTION OF THE DRAWINGS

FIG. 1 is a schematic sectional illustration of an aircraft propulsion system with a ducted propulsor rotor.

FIG. 2 is a schematic end view illustration of a portion of the aircraft propulsion system at a clearance control system.

FIG. 3 is a schematic sectional illustration of a portion of the aircraft propulsion system at the clearance control system.

FIG. 4 is a graphical representation of an engine case with various thermally induced geometries.

FIG. 5 is a schematic sectional illustration of a portion of the aircraft propulsion system at the clearance control system with another clearance control structure arrangement.

FIG. 6 is a schematic end view illustration along a core flowpath arranged with flowpath temperature sensors.

FIG. 7 is a schematic illustration of a portion of the aircraft propulsion system at the clearance control system with multiple clearance control structures.

FIGS. 8A and 8B are partial schematic illustrations of various air circuit arrangements.

FIG. 9 is a schematic sectional illustration of the aircraft propulsion system with an open propulsor rotor.

### DETAILED DESCRIPTION

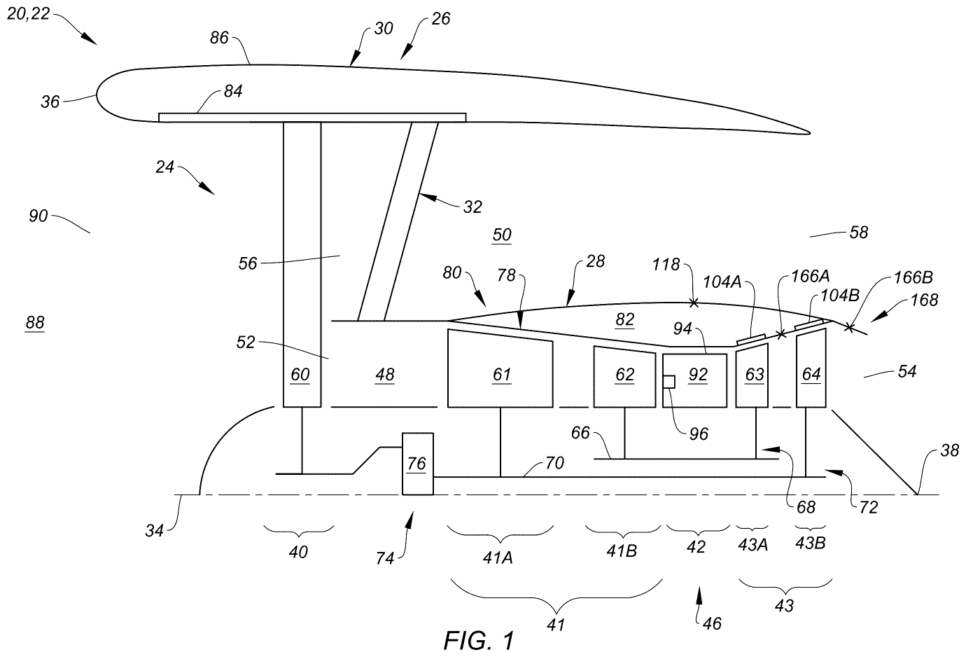

FIG. 1 illustrates a powerplant 20 for an aircraft. The aircraft may be an airplane, a drone (e.g., an unmanned aerial vehicle (UAV)) or any other manned or unmanned aerial vehicle or system. For ease of description, the aircraft powerplant 20 is described below as a propulsion system 22 for the aircraft and, more particularly, as a turbofan propulsion system. The aircraft powerplant 20 of the present disclosure, however, is not limited to such an exemplary propulsion system. The aircraft propulsion system 22, for example, may alternatively be configured as a turbojet propulsion system, a turboprop propulsion system, a turboshaft propulsion system, a propfan propulsion system, a pusher fan propulsion system, or any other type of ducted and/or open propulsor rotor propulsion system. Moreover, the aircraft powerplant 20 is not limited to propulsion system applications. The aircraft powerplant 20, for example, may also (or alternatively) be configured as an electrical power system for the aircraft; e.g., an auxiliary power unit (APU).

The aircraft propulsion system 22 includes a gas turbine engine 24 (e.g., a turbofan engine) housed within a stationary propulsion system housing 26, which propulsion system housing 26 of FIG. 1 includes an inner housing structure 28, an outer housing structure 30 and a guide vane structure 32 (e.g., a fan exit guide vane (FEGV) structure) extending radially between and connected to the inner housing structure 28 and the outer housing structure 30. The aircraft propulsion system 22 extends axially along an axis 34 of the aircraft propulsion system 22 between an axial upstream, forward end 36 of the aircraft propulsion system 22 and an axial downstream, aft end 38 of the aircraft propulsion system 22. Briefly, the propulsion system axis 34 may be a centerline axis of the aircraft propulsion system 22, the turbine engine 24 and/or one or more of its members. The propulsion system axis 34 may also or alternatively be a rotational axis for one or more members of the turbine engine 24.

The aircraft propulsion system 22 and its turbine engine 24 of FIG. 1 include a propulsor section 40 (e.g., a fan section), a compressor section 41, a combustor section 42 and a turbine section 43. The compressor section 41 of FIG. 1 includes a low pressure compressor (LPC) section 41A and a high pressure compressor (HPC) section 41B. The turbine section 43 of FIG. 1 includes a high pressure turbine (HPT) section 43A and a low pressure turbine (LPT) section 43B. At least (or only) the LPC section 41A, the HPC section 41B, the combustor section 42, the HPT section 43A and the LPT section 43B collectively form a core 46 (e.g., a gas generator) of the turbine engine 24. The aircraft propulsion system 22 and its turbine engine 24 of FIG. 1 also include a core flowpath 48 (e.g., an annular core flowpath) and a bypass flowpath 50 (e.g., an annular bypass flowpath). The core flowpath 48 extends sequentially through the LPC section 41A, the HPC section 41B, the combustor section 42, the HPT section 43A and the LPT section 43B from an airflow inlet 52 into the core flowpath 48 to a combustion products exhaust 54 out from the core flowpath 48. The bypass flowpath 50 extends through a bypass duct from an airflow inlet 56 into the bypass flowpath 50 to an airflow exhaust 58 from the bypass flowpath 50, where the bypass duct may be formed by the inner housing structure 28 and the outer housing structure 30. The bypass flowpath 50 and its bypass duct are configured to bypass (e.g., are disposed radially outboard of and extend along) the engine core 46 and the inner housing structure 28.

The propulsor section 40, the LPC section 41A, the HPC section 41B, the combustor section 42, the HPT section 43A and the LPT section 43B may be arranged sequentially along the propulsion system axis 34 within the propulsion system housing 26. The propulsor section 40 includes a bladed propulsor rotor 60; e.g., a fan rotor. The LPC section 41A includes a bladed low pressure compressor (LPC) rotor 61. The HPC section 41B includes a bladed high pressure compressor (HPC) rotor 62. The HPT section 43A includes a bladed high pressure turbine (HPT) rotor 63. The LPT section 43B includes a bladed low pressure turbine (LPT) rotor 64. Each of these engine rotors 60-64 includes a rotor base (e.g., a disk or a hub) and a plurality of rotor blades (e.g., airfoils, vanes, etc.). The rotor blades may be arranged into one or more stages axially along the respective engine rotor 60-64. The rotor blades in each stage are arranged and may be equispaced circumferentially around the respective rotor base in an annular array. Each of the rotor blades is connected to the respective rotor base. The rotor blades, for example, may be formed integral with or mechanically fastened, welded, brazed and/or otherwise attached to the respective rotor base. Each of the rotor blades projects spanwise (e.g., radially) out from the respective rotor base to a distal tip of the respective rotor blade.

The HPC rotor 62 is coupled to and rotatable with the HPT rotor 63. The HPC rotor 62 of FIG. 1, for example, is connected to the HPT rotor 63 through a high speed shaft 66. At least (or only) the HPC rotor 62, the HPT rotor 63 and the high speed shaft 66 collectively form a high speed rotating structure 68; e.g., a high speed spool of the turbine engine 24 and its engine core 46. This high speed rotating structure 68 of FIG. 1 and its members 62, 63 and 66 are rotatable about the propulsion system axis 34. However, it is contemplated the high speed rotating structure 68 may alternatively be rotatable about another axis radially and/or angularly offset from the rotational axis of the propulsor rotor 60 and/or the centerline axis of the turbine engine 24.

The LPC rotor 61 is coupled to and rotatable with the LPT rotor 64. The LPC rotor 61 of FIG. 1, for example, is connected to the LPT rotor 64 through a low speed shaft 70. At least (or only) the LPC rotor 61, the LPT rotor 64 and the low speed shaft 70 collectively form a low speed rotating structure 72; e.g., a low speed spool of the turbine engine 24 and its engine core 46. This low speed rotating structure 72 of FIG. 1 and its members 61, 64 and 70 are rotatable about the propulsion system axis 34. However, it is contemplated the low speed rotating structure 72 may alternatively be rotatable about another axis radially and/or angularly offset from the rotational axis of the propulsor rotor 60 and/or the centerline axis of the turbine engine 24.

The low speed rotating structure 72 is coupled to the propulsor rotor 60 through a rotating structure-to-propulsor (RSP) drivetrain 74. The RSP drivetrain 74 may be configured as a geared drivetrain, where a geartrain 76 (e.g., a transmission, a speed change device, an epicyclic geartrain, etc.) is disposed between and operatively couples the propulsor rotor 60 to the low speed rotating structure 72 and its LPT rotor 64. With this arrangement, the propulsor rotor 60 may rotate at a different (e.g., slower) rotational speed than the low speed rotating structure 72 and its LPT rotor 64. Here, the propulsor rotor 60 and the low speed rotating structure 72 may rotate in a common (the same) direction about the propulsion system axis 34 or in opposite directions about the propulsion system axis 34 depending, for example, upon the specific configuration of the geartrain 76. Alternatively, the RSP drivetrain 74 may be configured as a direct-drive drivetrain, where the geartrain 76 is omitted. With such an arrangement, the propulsor rotor 60 rotates at a common (the same) rotational speed as the low speed rotating structure 72 and its LPT rotor 64.

The inner housing structure 28 of FIG. 1 includes an inner case 78 (e.g., a core case) for the turbine engine 24, an inner nacelle structure 80 (sometimes referred to as an inner fixed structure (IFS)) and an internal inner housing compartment 82 (e.g., an engine core compartment). The inner case 78 is disposed radially outboard of, extends axially along and may circumscribe one or more or all of the engine sections 41A-43B and the engine rotors 61-64. The inner case 78 may thereby house and provide a support structure for the respective engine sections 41A-43B and the engine rotors 61-64. The inner nacelle structure 80 is configured to provide an aerodynamic cover over the engine core 46 and its inner case 78. The inner housing compartment 82 of FIG. 1 is formed by and is disposed radially between the inner case 78 and an inner barrel of the inner nacelle structure 80. The inner housing structure 28 and its inner nacelle structure 80 may also form a radial inner peripheral boundary of the bypass flowpath 50.

The outer housing structure 30 of FIG. 1 includes an outer case 84 (e.g., a fan case) for the turbine engine 24 and an outer nacelle structure 86. The outer case 84 is disposed radially outboard of, extends axially along and may circumscribe the propulsor section 40 and its propulsor rotor 60. The outer case 84 may thereby house and may be configured as a containment structure for the propulsor section 40 and its propulsor rotor 60. The outer nacelle structure 86 is configured to provide an aerodynamic cover over the outer case 84. The outer housing structure 30 and its outer nacelle structure 86 may also form a radial outer peripheral boundary of the bypass flowpath 50.

During operation of the aircraft propulsion system 22 of FIG. 1, ambient air from an environment 88 external to the aircraft and its aircraft propulsion system 22 enters the aircraft propulsion system 22 and its turbine engine 24 through an airflow inlet 90. This air is propelled by the rotating propulsor rotor 60 in a downstream, aft direction towards the propulsion system aft end 38.

An outer stream of the air propelled by the rotating propulsor rotor 60 is directed into the bypass flowpath 50 through its bypass inlet 56, which air entering the bypass flowpath 50 may be referred to as “bypass air”. The guide vane structure 32 conditions (e.g., straightens out, de-swirls, etc.) the flow of the bypass air within the bypass duct. This conditioned bypass air is subsequently directed out of the aircraft propulsion system 22 through the bypass exhaust 58 to provide forward thrust. This propulsion of the bypass air may account for a majority of the forward thrust generated by the aircraft propulsion system 22 and its turbine engine 24 of FIG. 1.

An inner stream of the air propelled by the rotating propulsor rotor 60 is directed into the core flowpath 48 through its core inlet 52, which air entering the core flowpath 48 may be referred to as “core air”. This core air is compressed by the LPC rotor 61 and the HPC rotor 62 and is directed into a combustion chamber 92 (e.g., annular combustion chamber) of a combustor 94 (e.g., annular combustor) in the combustor section 42. Fuel is injected into the combustion chamber 92 by one or more fuel injectors 96 and mixed with the compressed core air to provide a fuel-air mixture. This fuel-air mixture is ignited and combustion products thereof flow through and sequentially drive rotation of the HPT rotor 63 and the LPT rotor 64. The rotation of the HPT rotor 63 and the LPT rotor 64 respectively drive rotation of the HPC rotor 62 and the LPC rotor 61 and, thus, compression of the air received from the core inlet 52. The rotation of the LPT rotor 64 also drives rotation of the propulsor rotor 60 through the RSP drivetrain 74.

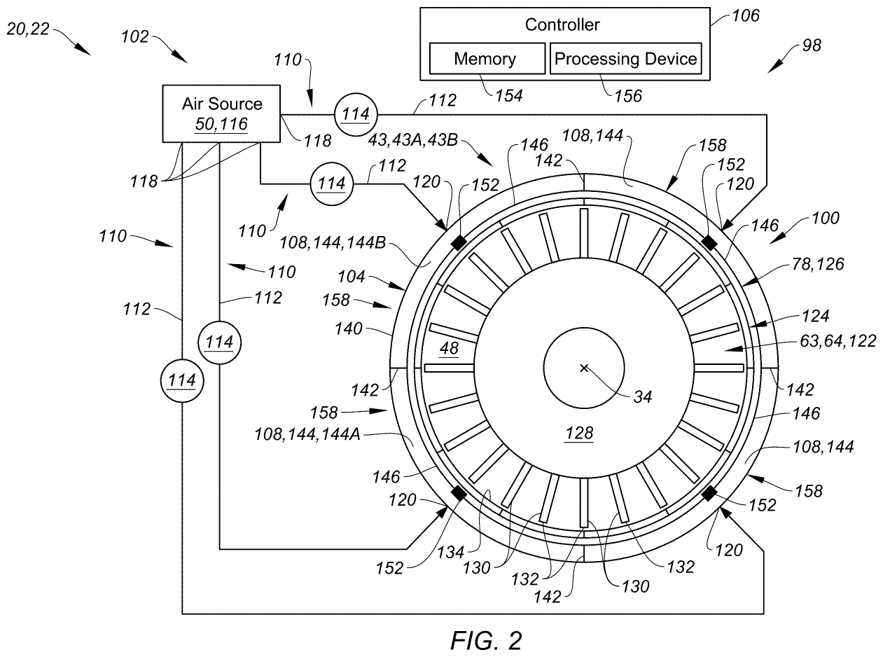

Referring to FIG. 2, the aircraft propulsion system 22 includes a clearance control system 98 (e.g., an active clearance control (ACC) system) arranged with and servicing a rotor system 100 of the turbine engine 24 and its engine core 46 (see FIG. 1). This clearance control system 98 includes an air system 102 and a clearance control structure 104. The clearance control system 98 of FIG. 2 also includes a sensor system and a controller 106.

The air system 102 is configured to selectively provide pressurized air (e.g., bleed air, ram air, etc.) to the clearance control structure 104. More particularly, the air system 102 of FIG. 2 is configured to selectively provide the pressurized air to one or more cooling zones 108 of the clearance control structure 104. For ease of description, the clearance control structure 104 of FIG. 2 is described below with four (4) of the cooling zones 108. However, it is contemplated the clearance control structure 104 may alternatively include less than four (4) cooling zones 108, or more than four (4) cooling zones 108. The air system 102 of FIG. 2 includes one or more air circuits 110. Each of these air circuits 110 of FIG. 2 includes a circuit passage 112 and a flow regulator 114.

Each air circuit 110 and its circuit passage 112 are configured to fluidly couple an air source 116 to the clearance control structure 104. More particularly, each air circuit 110 and its circuit passage 112 are configured to fluidly couple the air source 116 to a respective one of the cooling zones 108 of the clearance control structure 104. Each circuit passage 112 of FIG. 2, for example, extends longitudinally from an airflow inlet 118 into the respective air circuit 110 and its circuit passage 112 to an airflow outlet 120 from the respective air circuit 110 and its circuit passage 112. Each circuit inlet 118 is fluidly coupled to the air source 116, for example independent from the circuit inlets 118 of the other air circuits 110. Each circuit outlet 120 is fluidly coupled to an airflow inlet into a respective one of the cooling zones 108 of the clearance control structure 104.

The air source 116 may be a source of air that is internal to the aircraft propulsion system 22. The air source 116, for example, may be configured as the bypass flowpath 50. With such a configuration, each circuit inlet 118 fluidly couples the bypass flowpath 50 to the respective air circuit 110 and, more particularly, to the respective circuit passage 112. Referring to FIG. 1, each circuit inlet 118 may be formed in and/or otherwise arranged with a wall of the inner housing structure 28 along the inner peripheral boundary of the bypass flowpath 50. Here, each circuit inlet 118 may be configured as or otherwise include a bleed port (or multiple bleed ports) and/or an air scoop (or multiple air scoops). The present disclosure, however, is not limited to such an exemplary circuit inlet arrangement. For example, one or more of the circuit inlets 118 may alternatively be arranged elsewhere with the bypass flowpath 50. Moreover, it is contemplated the air source 116 (see FIG. 2) may alternatively be configured as another volume internal to the aircraft propulsion system 22 such as the core flowpath 48. In still another example, it is contemplated the air source 116 (see FIG. 2) may alternatively be configured as a volume external to the aircraft propulsion system 22 such as the external environment 88 (see FIG. 1).

Each flow regulator 114 is fluidly coupled inline along a respective one of the circuit passages 112 between the air source 116 and a respective one of the cooling zones 108 of the clearance control structure 104. Each circuit passage 112 of FIG. 2, for example, extends through the respective flow regulator 114 between the respective circuit inlet 118 and the respective circuit outlet 120. More particularly, each flow regulator 114 of FIG. 2 is longitudinally spaced downstream of the respective circuit inlet 118 along the respective circuit passage 112. The air system 102 of the present disclosure, however, is not limited to such an exemplary arrangement. Each flow regulator 114, for example, may alternatively be disposed adjacent or may form the respective circuit inlet 118. Still other examples of suitable flow regulator arrangements are described below in further detail.

Each flow regulator 114 is configured to regulate the flow of air directed through the respective air circuit 110 from its circuit inlet 118 to the respective cooling zone 108 of the clearance control structure 104. Each flow regulator 114, for example, may be configured as or otherwise include a flow diverter, a control valve and/or a valve system. With a respective flow regulator 114 open, that flow regulator 114 may fluidly couple the air source 116 to the respective cooling zone 108 of the clearance control structure 104. With a respective flow regulator 114 closed, that flow regulator 114 may fluidly decouple the air source 116 from the respective cooling zone 108 of the clearance control structure 104 (or facilitate a minimum flow of the pressurized air from the air source 116 to the respective cooling zone 108 of the clearance control structure 104). Of course, it is also contemplated a respective flow regulator 114 may partially open (or partially close) to facilitate an intermediate metered flow of the pressurized air from the air source 116 to the respective cooling zone 108 of the clearance control structure 104.

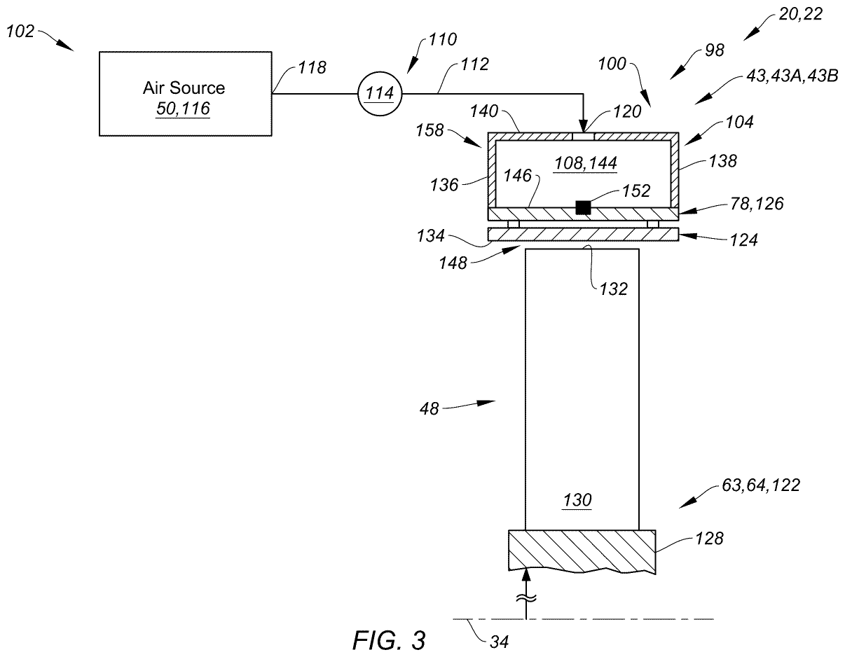

The clearance control structure 104 is arranged with and is configured to facilitate the service of the rotor system 100. This rotor system 100 of FIG. 2 includes an engine rotor 122, an outer rotor shroud 124 (e.g., a blade outer air seal (BOAS)) and an engine casing 126. For ease of description, the rotor system 100 is described below as being part of the turbine section 43. For example, where the rotor system 100 is part of the HPT section 43A, the engine rotor 122 is configured as the HPT rotor 63, the rotor shroud 124 is configured as a high pressure turbine (HPT) shroud for the HPT rotor 63, and the engine casing 126 is configured as a high pressure turbine (HPT) casing housing the HPT rotor 63 and its HPT shroud. In another example, where the rotor system 100 is part of the LPT section 43B, the engine rotor 122 is configured as the LPT rotor 64, the rotor shroud 124 is configured as a low pressure turbine (LPT) shroud for the LPT rotor 64, and the engine casing 126 is configured as a low pressure turbine (LPT) casing housing the LPT rotor 64 and its LPT shroud. The present disclosure, however, is not limited to such exemplary configurations. For example, the rotor system 100 may alternatively be configured as part of an intermediate pressure turbine (IPT) section or a power turbine (PT) section of the turbine engine 24 (as applicable). Moreover, for ease of description, the engine rotor 122 is generally described below and illustrated in FIG. 3 with a single rotor blade stage and the clearance control structure 104 is arranged with that single rotor blade stage. However, it is contemplated, the engine rotor 122 may alternatively include multiple rotor blade stages. In such embodiments, any one, more or all of those rotor blade stages may be arranged with a unique one of the clearance control structures. Alternatively, a single clearance control structure 104 may be configured to service multiple rotor blade stages of the same engine rotor 122.

The engine rotor 122 of FIG. 2 includes a rotor base 128 (e.g., a disk or a hub) and a plurality of rotor blades 130 (e.g., airfoils, vanes, etc.). The rotor blades 130 are arranged and may be equispaced circumferentially around the respective rotor base 128 in an annular array. Each of the rotor blades 130 projects radially (e.g., spanwise) out from the respective rotor base 128 into the core flowpath 48 and to a distal tip 132 of the respective rotor blade 130.

The rotor shroud 124 is disposed radially outboard of the array of the rotor blades 130 and radially next to the blade tips 132. The rotor shroud 124 overlaps the array of the rotor blades 130 and the blade tips 132 longitudinally along the core flowpath 48 and axially along the propulsion system axis 34. The rotor shroud 124 extends circumferentially around the propulsion system axis 34 thereby circumscribing the engine rotor 122 and its array of the rotor blades 130. With this arrangement, a radial inner side 134 of the rotor shroud 124 forms a radial outer peripheral boundary of the core flowpath 48 longitudinally across the array of the rotor blades 130. The rotor shroud 124 is also disposed radially inboard of and mounted to the engine casing 126. The rotor shroud 124 may thereby be supported by the engine casing 126.

The engine casing 126 may be configured as a standalone axial section of the inner case 78 (see also FIG. 1). This engine casing 126 partially or completely houses (e.g., axially overlaps and circumscribes) at least the engine rotor 122 and its associated rotor shroud 124. With such an arrangement, the engine casing 126 (e.g., the HPT casing) associated with the HPT rotor 63 (see FIG. 1) may be formed as a discrete body from the engine casing 126 (e.g., the LPT casing) associated with the LPT rotor 64 (see FIG. 1). The present disclosure, however, is not limited to such an exemplary arrangement. For example, the engine casing 126 may alternatively house multiple engine rotors (e.g., the HPT rotor 63 and the LPT rotor 64 of FIG. 1) within the turbine engine 24 and its engine core 46.

The clearance control structure 104 may be configured as a cooling shroud disposed radially outboard of the engine casing 126. The clearance control structure 104 of FIG. 3, for example, includes a first endwall 136, a second endwall 138 and a sidewall 140. Referring to FIG. 2, the clearance control structure 104 and each of its members 136, 138 and 140 (see FIG. 3) may extend circumferentially around (e.g., circumscribe) the engine casing 126. This clearance control structure 104 of FIG. 2 also includes one or more fluid barriers 142; e.g., walls, baffles, etc.

Referring to FIG. 3, the clearance control structure 104 extends axially along the engine casing 126 from the structure first endwall 136 to the structure second endwall 138. Here, the clearance control structure 104 axially overlaps the array of the rotor blades 130. The clearance control structure 104 may also project axially along the propulsion system axis 34 away from the array of the rotor blades 130 (in an upstream direction relative to the core flowpath 48) to the structure first endwall 136. The clearance control structure 104 may still also or alternatively project axially along the propulsion system axis 34 away from the array of the rotor blades 130 (in a downstream direction relative to the core flowpath 48) to the structure second endwall 138.

The structure sidewall 140 is spaced radially outboard from the engine casing 126. The structure sidewall 140 extends axially between and is connected to the structure first endwall 136 and the structure second endwall 138.

Referring to FIG. 2, the fluid barriers 142 are arranged and may (or may not) be equispaced circumferentially about the engine casing 126 and the propulsion system axis 34 in an array; e.g., an annular array. Each fluid barrier 142 of FIG. 2 projects radially out from (or about) the engine casing 126 to (or about) the structure sidewall 140. Each fluid barrier 142 extends axially from (or about) the structure first endwall 136 of FIG. 3 to (or about) the structure second endwall 138 of FIG. 3. With this configuration, the fluid barriers 142 of FIG. 2 may divide a volume between the clearance control structure 104 and the engine casing 126 into one or more air plenums 144. These air plenums 144 are arranged and may (or may not) be equispaced circumferentially about the engine casing 126 and the propulsion system axis 34 in an array; e.g., an annular array. Each circumferentially neighboring pair of the air plenums 144 may be fluidly separated by a respective one of the fluid barriers 142. Referring to FIG. 3, each air plenum 144 extends radially from the engine casing 126 to the structure sidewall 140. Each air plenum 144 extends axially within the clearance control structure 104 between the structure first endwall 136 and the structure second endwall 138.

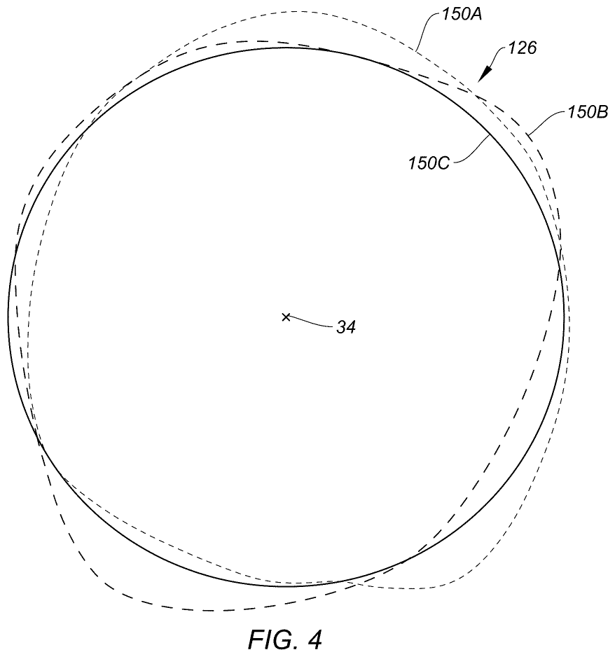

Each air plenum 144 of FIG. 2 forms a respective one of the cooling zones 108. Each air plenum 144 extends circumferentially along and borders a respective circumferential section 146 of the engine casing 126. Each air plenum 144 is fluidly coupled to the circuit outlet 120 of a respective one of the air circuits 110. With this arrangement, each air plenum 144 may receive a flow of the pressurized air from a respective one of the air circuits 110. Within the respective air plenum 144, the pressurized air may flow circumferentially and/or axially along the respective section 146 of the engine casing 126. The pressurized air may thereby convectively cool the respective section 146 of the engine casing 126. By regulating the flow of the pressurized air into each air plenum 144 with the respective flow regulator 114, a radial tip clearance 148 of FIG. 3 (e.g., a radial gap) between the rotor shroud 124 and the blade tips 132 may be controlled; e.g., increased, decreased and/or maintained. For example, by increasing the airflow into one or more of the air plenums 144 surrounding the engine casing 126, additional air is available for cooling of the engine casing 126. This increased cooling may decrease a size (e.g., a diameter) of the engine casing 126 through thermal contraction of material forming the engine casing 126. The thermal contraction of the engine casing 126 in turn may locate circumferential segments of the rotor shroud 124 supported by the engine casing 126 further radially inboard towards the propulsion system axis 34; e.g., towards the blade tips 132. In contrast, by decreasing the airflow into one or more of the air plenums 144 surrounding the engine casing 126, less air is available for cooling the engine casing 126. This decreased cooling may allow the material forming the engine casing 126 to heat up and thermally expand, thereby increasing the size of the engine casing 126. The thermal expansion of the engine casing 126 in turn may locate the circumferential segments of the rotor shroud 124 supported by the engine casing 126 further radially outboard away from the propulsion system axis 34; e.g., away from the blade tips 132. The clearance control structure 104 of FIGS. 3 and 4 may thereby control the tip clearance 148 using the pressurized air received from the respective air circuits 110.

Referring to FIG. 2, under ideal engine operation, a material temperature of the engine casing 126 may be substantially constant circumferentially around the propulsion system axis 34. However, in practice, the combustion products flowing through the core flowpath 48 across the engine rotor 122 may include one or more thermal hot spots. More particularly, a temperature of the combustion products within the core flowpath 48 may vary circumferentially around the propulsion system axis 34. The rotor shroud 124 and the engine casing 126 may thereby be subject to a non-uniform thermal gradient circumferentially around the propulsion system axis 34. Referring to FIG. 4, such a non-uniform thermal gradient may subject the engine casing 126 to non-uniform deformation (e.g., thermal expansion and/or thermal contraction) such as ovalization; e.g., see lines 150A and 150B. Referring to FIG. 3, such non-uniform deformation may lead to variation in the tip clearance 148 between the rotor blade tips 132 and the rotor shroud 124 circumferentially around the propulsion system axis 34. The clearance control system 98 of the present disclosure, however, is operable to reduce (e.g., minimize) or prevent such non-uniform deformation of the engine casing 126 using the sensor system and the controller 106; e.g., see line 150C of FIG. 4.

The sensor system is configured to monitor deformation of the engine casing 126. The sensor system of FIG. 2, for example, includes a plurality of casing temperature sensors 152. Each of these casing temperature sensors 152 is arranged with and is configured to monitor a temperature of a respective one of the sections 146 of the engine casing 126. The sensor system is also configured to provide the controller 106 with sensor data indicative of the monitored temperatures of the engine casing sections 146.

The controller 106 is in signal communication (e.g., hardwired and/or wirelessly coupled) with the sensor system and its casing temperature sensors 152 as well as the air system 102 and its flow regulators 114. The controller 106 may be implemented with a combination of hardware and software. The hardware may include memory 154 and at least one processing device 156, which processing device 156 may include one or more single-core and/or multi-core processors. The hardware may also or alternatively include analog and/or digital circuitry other than that described above.

The memory 154 is configured to store software (e.g., program instructions) for execution by the processing device 156, which software execution may control and/or facilitate performance of one or more operations such as those described herein. The memory 154 may be a non-transitory computer readable medium. For example, the memory 154 may be configured as or include a volatile memory and/or a nonvolatile memory. Examples of a volatile memory may include a random access memory (RAM) such as a dynamic random access memory (DRAM), a static random access memory (SRAM), a synchronous dynamic random access memory (SDRAM), a video random access memory (VRAM), etc. Examples of a nonvolatile memory may include a read only memory (ROM), an electrically erasable programmable read-only memory (EEPROM), a computer hard drive, etc.

During operation of the clearance control system 98, the sensor system may monitor the temperatures of the engine casing sections 146 using the casing temperature sensors 152. The sensor system may subsequently provide the sensor data to the controller 106, which sensor data is indicative of the monitored engine casing section temperatures. The controller 106 may process the sensor data to determine whether or not the engine casing 126 is subject to non-uniform deformation such as ovalization. For example, where the temperature associated with one of the engine casing sections 146 is different (e.g., higher or lower) than the temperature(s) of one or more of the other engine casing sections 146, the controller 106 may determine the engine casing 126 may be subject to non-uniform deformation such as ovalization. To mitigate or prevent such non-uniform deformation of the engine casing 126, the controller 106 may signal the flow regulators 114 to: (a) selectively direct more of the pressurized air (e.g., at a higher flowrate) to the cooling zone(s) 108 associated with the higher measured temperature(s) and/or (b) direct less of the pressurized air (e.g., at a lower flowrate) to the cooling zone(s) 108 associated with the lower measured temperature(s). More particularly, the flow regulators 114 may be controlled such that one or more of the air circuits 110 directs the pressurized air from the air source 116 to the respective air plenum(s) 144 at a higher flowrate than one or more of the other air circuits 110. The clearance control system 98 may thereby cool to the engine casing 126 with the pressurized air asymmetrically around the propulsion system axis 34 to counter effects of circumferential asymmetric thermal gradients in the engine casing 126. Of course, under certain operating conditions, it is contemplated the controller 106 may alternatively signal the flow regulators 114 to provide uniform flows of the pressurized air (e.g., at equal flowrates) to the clearance control structure 104 and its cooling zones 108. More particularly, the flow regulators 114 may be controlled such that all of the air circuits 110 direct the pressurized air from the air source 116 to the respective air plenums 144 at a common (the same) flowrate. Such uniform cooling may be provided, for example, where the measured temperatures of the engine casing sections 146 are within a certain threshold range of one another; e.g., deviation between the temperatures is less than one degree, or five degrees or ten degrees.

It should be noted, during turbine engine operation, it is contemplated the thermal hot spots may be located at different circumferential positions during different power settings. Therefore, at a first power setting, a first of the air plenums 144 (e.g., 144A of FIG. 2) may receive a higher flow of the pressurized air than a second of the air plenums 144 (e.g., 144B of FIG. 2). By contrast, at a second power setting, the first of the air plenums 144 (e.g., 144A) may receive a lower flow of the pressurized air than the second of the air plenums 144 (e.g., 144B). These first and the second air plenums (e.g., 144A and 144B) may be circumferentially next to one another as shown in FIG. 2. Alternatively, the first and the second air plenums (e.g., 144A and 144B) may be circumferentially spaced apart by one or more other air plenums 144; e.g., the first and the second air plenums (e.g., 144A and 144B) may be diametrically opposite one another.

In some embodiments, the clearance control system 98 may tune (e.g., adjust) the flow of the pressurized air from the air source 116, through the air circuits 110, and into the air plenums 144 based on the engine casing section temperatures as described above. The present disclosure, however, is not limited to such an exemplary methodology. For example, it is contemplated the sensor system may also or alternatively monitor one or more other engine operating parameters, where those engine operating parameter(s) may be processed by the controller 106 to detect and/or characterize non-uniform deformation of the engine casing 126. For example, the casing temperature sensors 152 may be replaced by or paired with stress and/or strain sensors.

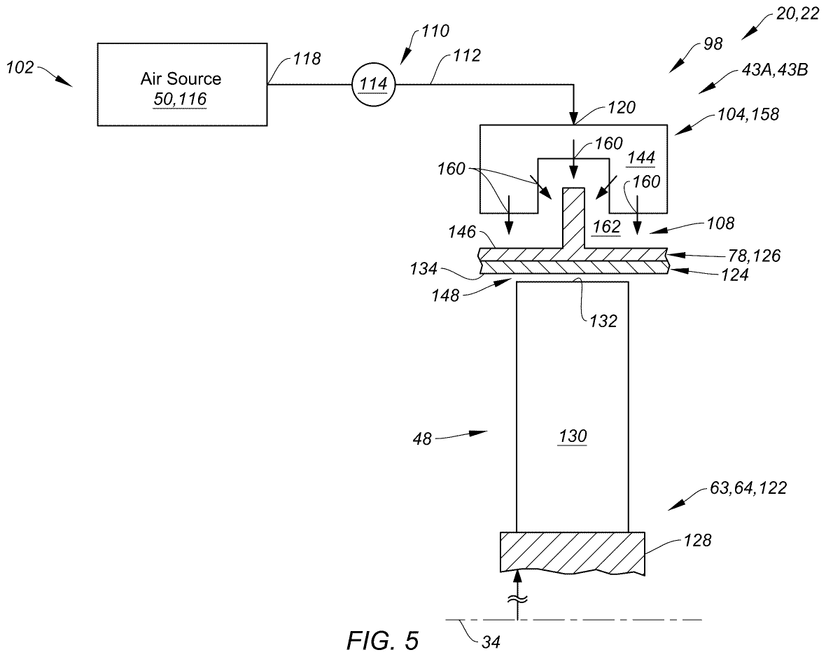

In some embodiments, referring to FIGS. 2 and 3, the clearance control structure 104 and the engine casing 126 may collectively form a plurality of clearance control manifolds 158. Each of these clearance control manifolds 158 includes a respective one of the air plenums 144. In other embodiments, referring to FIG. 5, the clearance control structure 104 may form the clearance control manifolds 158 (one visible in FIG. 5) independent of the engine casing 126. With such a configuration, the clearance control structure 104 and each of its clearance control manifolds 158 are spaced radially outboard from the engine casing 126. Each clearance control manifold 158 may include one or more (e.g., an array of) cooling apertures 160. These cooling apertures 160 may be configured to direct jets of the pressurized air into a volume 162 (e.g., another air plenum) between the clearance control manifold 158 and the engine casing section 146 to impinge against and/or otherwise flow along the engine casing section 146. The present disclosure, however, is not limited to such exemplary clearance control structures.

Referring to FIGS. 2 and 3, operation of the clearance control system 98 is described above for mitigating and/or preventing non-uniform deformation of the engine casing 126 such as ovalization. The clearance control system 98, however, may also or alternatively be operated to mitigate adverse effects associated with material degradation of the rotor system 100 over time. This rotor system degradation may include material loss from the rotor shroud 124 over time. For example, the material of the rotor shroud 124 bordering the core flowpath 48 may be worn away during incidental rubbing between the rotor blades 130 and the rotor shroud 124. The rotor system degradation may also or alternatively include material loss from the rotor blades 130 over time. For example, the material of the rotor blades 130 at their rotor blade tips 132 may be worn away during the incidental rubbing between the rotor blades 130 and the rotor shroud 124. Of course, it is contemplated additional material may also or alternatively be worn away from the rotor shroud 124 and/or the rotor blades 130 due to erosion and/or the like. Following such material degradation, the actual tip clearance 148 between the rotor blade tips 132 and the surrounding rotor shroud 124 may be larger than expected; e.g., predicted, modeled, retrieved from a lookup table, etc. As the actual tip clearance 148 continues to increase over the expected tip clearance (e.g., a design tip clearance or an estimated tip clearance), more and more combustion products may leak across gaps between the rotor blade tips 132 and the surrounding rotor shroud 124. Therefore, as the actual tip clearance 148 continues to increase over the expected tip clearance, efficiency of the turbine engine 24 may degrade.

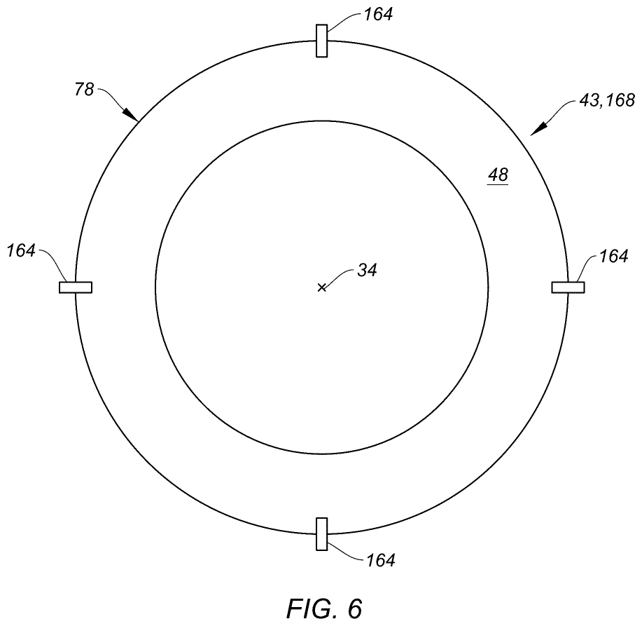

In some embodiments, the clearance control system 98 may be configured to detect material degradation of the rotor system 100 over time. For example, referring to FIG. 6, the sensor system may also or alternatively include one or more flowpath temperature sensors 164. These flowpath temperature sensors 164 may be arranged along the core flowpath 48 to monitor a temperature of the combustion products downstream of the rotor system 100 of interest. For example, where the rotor system 100 is part of the HPT section 43A, the flowpath temperature sensors 164 may be arranged along the core flowpath 48 (a) between the HPT section 43A and the LPT section 43B (e.g., at location 166A in FIG. 1), or (b) downstream of the LPT section 43B such as along an exhaust section 168 of the turbine engine 24 (e.g., at location 166B in FIG. 1)). In another example, where the rotor system 100 is part of the LPT section 43B, the flowpath temperature sensors 164 may be arranged along the core flowpath 48 downstream of the LPT section 43B such as along the exhaust section 168 of the turbine engine 24 (e.g., at the location 166B in FIG. 1). With such arrangements, sensor data provided by the flowpath temperature sensors 164 to the controller 106 may be indicative of the monitored temperature of the combustion products.

Using the sensor data provided by the flowpath temperature sensors 164, the controller 106 of FIG. 2 may identify presence of the material degradation of the rotor system 100 over time. For example, where the monitored temperature of the combustion products is higher than expected for a particular engine power setting, the controller 106 may determine additional combustion products may be leaking across the gaps between the rotor blade tips 132 and the surrounding rotor shroud 124. Under such conditions, the controller 106 may be tuned to mitigate the additional tip leakage. For example, one or more setpoints, control values and/or control terms in one or more algorithms and/or models used by the controller 106 may be modified and/or replaced such that the controller 106 is recalibrated (e.g., during engine operation and/or aircraft flight) to account at least partially for the material degradation of the rotor system 100. With such tuning, the controller 106 may facilitate operation of the clearance control system 98 such that more pressurized air is provided to the clearance control structure 104 than would otherwise be before the tuning. By providing this additional pressurized air, a size (e.g., a diameter) of the engine casing 126 and, thus, a size (e.g., a diameter) of the supported rotor shroud 124 may be constricted more than would otherwise be before the tuning. The tip clearance 148 may thereby be reduced in size following the identification of the material degradation of the rotor system 100. A useful life of the rotor system 100 may thereby be extended while also substantially maintaining turbine engine efficiency across a service life of the turbine engine 24.

The foregoing methodology may be performed incrementally so as to minimize the tip clearance 148. For example, the controller 106 may tune its programing to a first level and then assess whether additional tuning is needed. For example, where the monitored temperature of the combustion products matches the expected temperature of the combustion products following the first level tuning, then no additional tuning may be needed. In another example, where the monitored temperature of the combustion products is still higher than the expected following the first level tuning, then the controller 106 may tune its programing to a second level and then assess again whether additional tuning is needed.

The foregoing methodology monitors the temperature of the combustion products over a period of time. This period of time may be a temporal period during a single aircraft flight. Alternatively, the period of time may be a temporal period spanning across multiple aircraft flights.

In some embodiments, the clearance control system 98 may account for the material degradation of the rotor system 100 based on the combustion product temperatures as described above. The present disclosure, however, is not limited to such an exemplary methodology. For example, it is contemplated the sensor system may also or alternatively monitor one or more other engine operating parameters, where those engine operating parameter(s) may be processed by the controller 106 to detect material degradation of the rotor system 100.

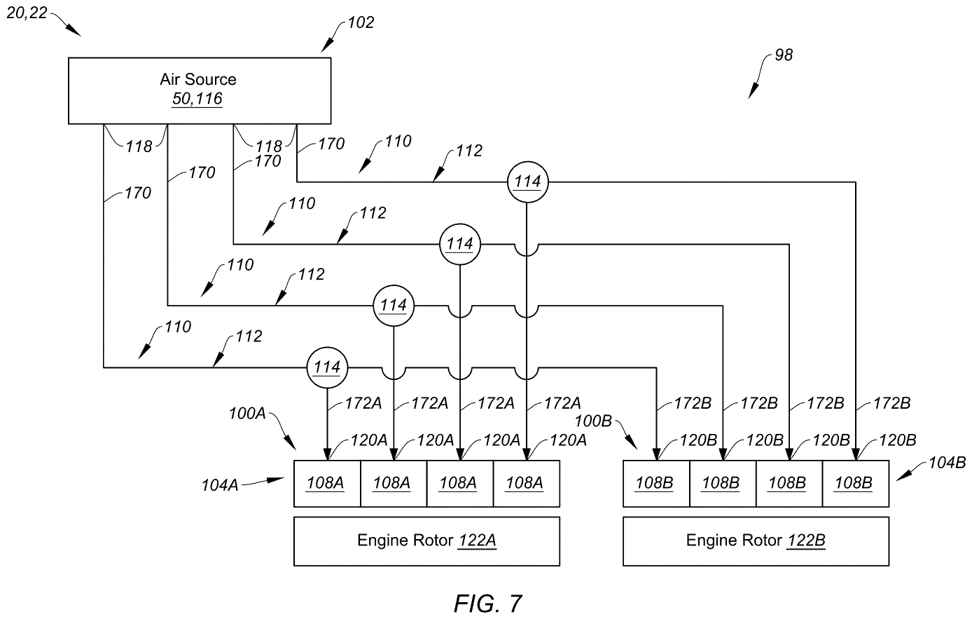

While the clearance control system 98 of FIG. 2 is generally described above with the single clearance control structure 104, the present disclosure is not limited thereto. For example, referring to FIG. 7, the clearance control system 98 may alternatively include multiple of the clearance control structures 104A and 104B (generally referred to as “104”). In some embodiments, these clearance control structures 104 may be arranged with and may facilitate the service of a common (the same) engine rotor; e.g., the HPT rotor 63 or the LPT rotor 64 of FIG. 1. For example, where the engine rotor includes multiple rotor blade stages, each clearance control structure 104 may be arranged with and configured to facilitate the service of a respective one of the rotor blade stages. In another example, the clearance control structures 104A and 104B may be arranged with and configured to facilitate the service of different engine rotors 122A and 122B (generally referred to as “122”). For example, the first clearance control structure 104A may be arranged with a rotor blade stage of the HPT rotor 63 and part of a first rotor system 100A, and the second clearance control structure 104B may be arranged with a rotor blade stage of the LPT rotor 64 and is configured as part of a second rotor system 100B. Each of the multiple clearance control structures 104 may (or may not) have a similar configuration as described above with respect to the clearance control system 98 of FIG. 2.

Each circuit passage 112 of FIG. 7 may be configured as a multi-path airflow passage. Each circuit passage 112 of FIG. 7, for example, includes a source leg 170 and one or more distribution legs 172A and 172B (generally referred to as “172”). The source leg 170 extends longitudinally from the respective circuit inlet 118 to an inlet into the respective flow regulator 114. The first distribution leg 172A extends longitudinally from an outlet from the respective flow regulator 114 to the respective circuit outlet 120A and, thus, a respective one of the first clearance control structure cooling zones 108A. The second distribution leg 172B extends longitudinally from another outlet from the respective flow regulator 114 to the respective circuit outlet 120B and, thus, a respective one of the second clearance control structure cooling zones 108B. With this arrangement, the distribution legs 172 are fluidly coupled in parallel to and downstream of the source leg 170.

Each flow regulator 114 of FIG. 7 is configured to regulate a flow of air through the respective air circuit 110 and its circuit passage 112 from the air source 116 to one or more of the clearance control structures 104 and their respective cooling zones 108. More particularly, each flow regulator 114 of FIG. 7 is configured to selectively fluidly couple the respective source leg 170 to the first distribution leg 172A and/or the second distribution leg 172B.

During one or more multi-leg modes of operation, a respective flow regulator 114 may fluidly couple the respective source leg 170 to each of the respective distribution legs 172. During one of the multi-leg operating modes, the respective flow regulator 114 may direct air from the respective source leg 170 into the respective distribution legs 172 at a common (the same) flow rate. During another one of the multi-leg operating modes, the respective flow regulator 114 may direct the air from the respective source leg 170 into the respective first distribution leg 172A at a flow rate that is greater than a flow rate of the air directed from the respective source leg 170 into the respective second distribution leg 172B. During still another one of the multi-leg operating modes, the respective flow regulator 114 may direct the air from the respective source leg 170 into the respective second distribution leg 172B at a flow rate that is greater than a flow rate of the air directed from the respective source leg 170 into the respective first distribution leg 172A.

During one or more first leg modes of operation, a respective flow regulator 114 may fluidly couple the respective source leg 170 to the respective first distribution leg 172A. The respective flow regulator 114 may also fluidly decouple the source leg 170 from the respective second distribution leg 172B (or facilitate a minimum flow of the air from the respective source leg 170 to the second distribution leg 172B). During one of the first leg operating modes, the respective flow regulator 114 may facilitate the flow of air from the respective source leg 170 to the respective first distribution leg 172A substantially or completely unrestricted; e.g., the respective flow regulator 114 may be fully opened to the respective first distribution leg 172A. During another one of the first leg operating modes, the respective flow regulator 114 may meter the flow of air from the respective source leg 170 to the respective first distribution leg 172A; e.g., the respective flow regulator 114 may be partially opened/partially closed to the respective first distribution leg 172A.

During one or more second leg modes of operation, a respective flow regulator 114 may fluidly couple the respective source leg 170 to the respective second distribution leg 172B. The respective flow regulator 114 may also fluidly decouple the source leg 170 from the respective first distribution leg 172A (or facilitate a minimum flow of the air from the respective source leg 170 to the first distribution leg 172A). During one of the second leg operating modes, the respective flow regulator 114 may facilitate the flow of air from the respective source leg 170 to the respective second distribution leg 172B substantially or completely unrestricted; e.g., the respective flow regulator 114 may be fully opened to the respective second distribution leg 172B. During another one of the second leg operating modes, the respective flow regulator 114 may meter the flow of air from the respective source leg 170 to the respective second distribution leg 172B; e.g., the respective flow regulator 114 may be partially opened/partially closed to the respective second distribution leg 172B.

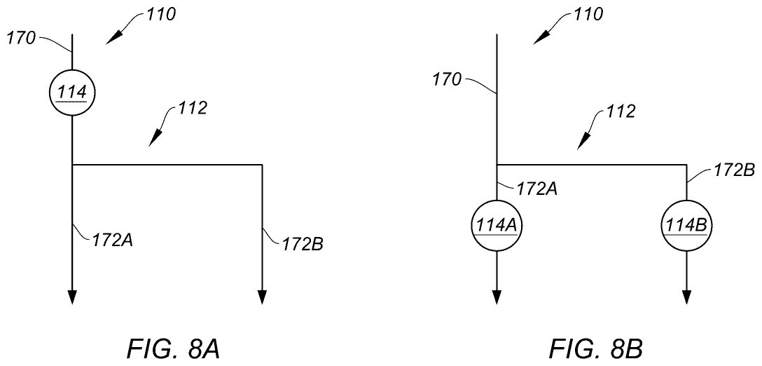

With the arrangement of FIG. 7, each flow regulator 114 is fluidly coupled inline along the respective circuit passage 112 at an intersection (e.g., a split) between the source leg 170 and the distribution legs 172. The present disclosure, however, is not limited to such an exemplary arrangement. For example, referring to FIG. 8A, a respective flow regulator 114 may alternatively be arranged along the respective source leg 170 upstream of the intersection between the source leg 170 and the distribution legs 172. With this arrangement of FIG. 8A, the flow regulator 114 regulates (e.g., permits, prevents and/or otherwise meters) the flow of air from the respective source leg 170 to both of the distribution legs 172. In another example, referring to FIG. 8B, multiple of the flow regulators 114A and 114B (generally referred to as “114”) may be included in each air circuit 110. With this arrangement of FIG. 8B, each flow regulator 114 is arranged along and regulates the flow of air through a respective one of the distribution legs 172.

The clearance control system 98 of FIG. 7 may be operated to mitigate and/or prevent the non-uniform deformation of the engine casing(s) associated with one, some or all of the clearance control structures 104. The clearance control system 98 of FIG. 7 may also or alternatively be operated to mitigate adverse effects caused by the material degradation of the rotor system(s) 100 associated with one, some or all of the clearance control structures 104. The foregoing operations associated with the first clearance control structure 104A may be independent of the operations associated with the second clearance control structure 104B, and vice versa. Alternatively, it is contemplated operation associated with one of the clearance control structures 104A, 104B may be piggybacked to the tuned operation associated with another one of the clearance control structures 104B, 104A.

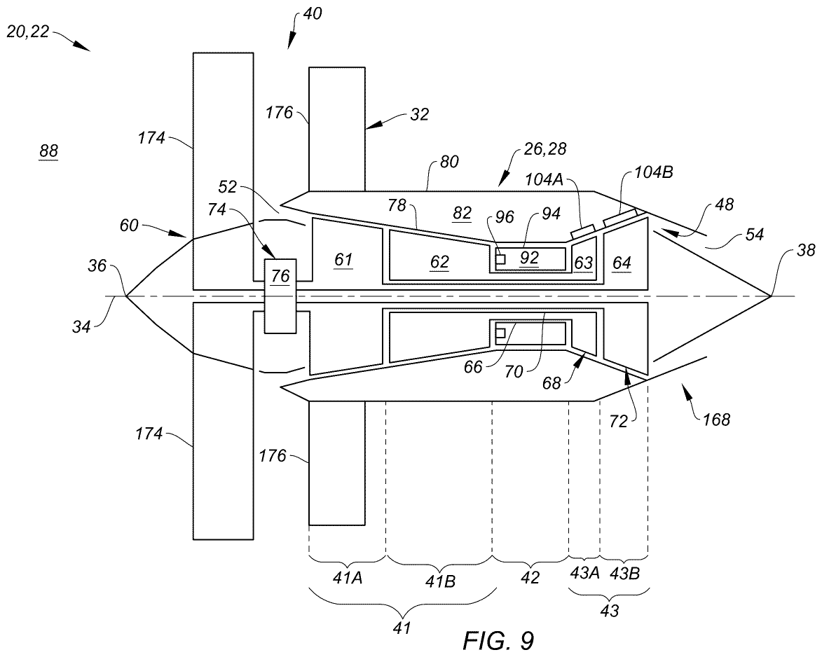

The aircraft propulsion system 22 of FIG. 1 is described above as a ducted propulsor propulsion system; e.g., the turbofan propulsion system. The present disclosure, however, is not limited to such an exemplary aircraft propulsion system. For example, referring to FIG. 9, the outer housing structure 30 (see FIG. 1) may be omitted from the propulsion system housing 26 to open the propulsor rotor 60 up to the external environment 88. More particularly, the propulsor rotor 60 of FIG. 9 includes a plurality of open propulsor blades 174 arranged circumferentially about the propulsion system axis 34 in an array; e.g., a circular array. This array of the propulsor blades 174 may be unshrouded or alternatively shrouded by a tubular propulsor rotor shroud dedicated to the propulsor rotor 60 for example. Each of these propulsor blades 174 projects spanwise (e.g., radially) out from a base of the propulsor rotor 60, into the external environment 88, to a distal tip of the respective propulsor blade 174. Each propulsor blade 174 is thereby configured as an un-ducted propulsor blade which is exposed to (e.g., disposed in) the surrounding external environment 88. With this arrangement, the propulsor rotor 60 is an open propulsor rotor (e.g., an un-ducted propulsor rotor) and the aircraft propulsion system 22 is configured as an open rotor propulsion system. Moreover, the inner housing structure 28 and its members may form an exterior of the aircraft propulsion system 22 and may border the external environment 88.

The guide vane structure 32 may also be open to the external environment 88 forming an open guide vane structure. This guide vane structure 32 of FIG. 9 includes a plurality of open exit guide vanes 176; e.g., airfoils. The guide vanes 176 are arranged and may (or may not) be equispaced circumferentially about the propulsion system axis 34 in an array; e.g., a circular array. This array of the guide vanes 176 may be unshrouded or alternatively shrouded by a tubular guide vane shroud dedicated to the guide vane structure 32 for example. This guide vane structure 32 and its guide vanes 176 are arranged axially next to (e.g., adjacent) the propulsor rotor 60 and its propulsor blades 174. The guide vane structure 32 and its guide vanes 176 of FIG. 9, for example, are arranged downstream of the propulsor rotor 60 and its propulsor blades 174, without (e.g., any) other elements axially therebetween to obstruct, turn and/or otherwise influence the air propelled by the propulsor rotor 60 to the guide vane structure 32. Each of the guide vanes 176 projects radially out from an exterior surface of the inner housing structure 28, into the external environment 88, to a distal tip of the respective guide vane 176. Each guide vane 176 is thereby configured as an un-ducted guide vane which is exposed to (e.g., disposed in) the surrounding external environment 88. With the foregoing arrangement, the guide vane structure 32 and its guide vanes 176 are configured to condition (e.g., straighten out, de-swirl, etc.) an outer stream of air propelled by the propulsor rotor 60 within the external environment 88 that bypass the engine core 46. Of course, in other embodiments, the guide vane structure 32 may be omitted where, for example, the aircraft propulsion system 22 is alternatively configured as a counter-rotating open rotor (CROR) aircraft propulsion system 22, etc.

While the turbine engine 24 in FIG. 1 and FIG. 9 is described above with a particular two rotating structure arrangement (e.g., a two-spool architecture), the present disclosure is not limited thereto. For example, the LPC rotor 61 may be omitted to configure the LPT rotor 64 as a power turbine (PT) rotor for the propulsor rotor 60. The turbine engine 24 may also or alternatively include another rotating structure with a bladed compressor rotor in the compressor section 41 and a bladed turbine rotor in the turbine section 43; e.g., an intermediate speed spool for the engine core 46.

While various embodiments of the present disclosure have been described, it will be apparent to those of ordinary skill in the art that many more embodiments and implementations are possible within the scope of the disclosure. For example, the present disclosure as described herein includes several aspects and embodiments that include particular features. Although these features may be described individually, it is within the scope of the present disclosure that some or all of these features may be combined with any one of the aspects and remain within the scope of the disclosure. Accordingly, the present disclosure is not to be restricted except in light of the attached claims and their equivalents.

1. A method of operating a turbine engine, comprising:
rotating a bladed turbine rotor about an axis, wherein a turbine shroud is next to and circumscribes the bladed turbine rotor; and
controlling a clearance between the bladed turbine rotor and the turbine shroud using a clearance control system, wherein operation of the clearance control system is tuned during turbine engine operation based on a change in an engine operating parameter over a period of time;
wherein the clearance control system is configured to selectively control air flowrates to different circumferential positions of a turbine casing supporting the turbine shroud based on at least one of a power setting of the turbine engine or measured temperatures about the turbine casing.

2. The method of claim 1, wherein the operation of the clearance control system is tuned over the period of time to reduce leakage between the bladed turbine rotor and the turbine shroud as at least one of the bladed turbine rotor or the turbine shroud degrades over the period of time.

3. The method of claim 1, wherein the operation of the clearance control system is tuned over the period of time to account for material worn away from the turbine shroud over the period of time.

4. The method of claim 1, wherein the bladed turbine rotor comprises a plurality of turbine blades, and the operation of the clearance control system is tuned over the period of time to account for material worn away from the plurality of turbine blades over the period of time.

5. The method of claim 1, wherein the engine operating parameter is indicative of a combustion products temperature at an exhaust section of the turbine engine.

6. The method of claim 1, wherein the engine operating parameter is indicative of a combustion products temperature at a turbine section of the turbine engine.

7. The method of claim 1, wherein the bladed turbine rotor is disposed in a high pressure turbine section of the turbine engine.

8. The method of claim 1, wherein the bladed turbine rotor is disposed in a low pressure turbine section of the turbine engine.

9. The method of claim 1, further comprising:
rotating a second bladed turbine rotor about the axis, wherein a second turbine shroud is next to and circumscribes the second bladed turbine rotor; and
controlling a clearance between the second bladed turbine rotor and the second turbine shroud using the clearance control system.

10. The method of claim 9, wherein the operation of the clearance control system is tuned independently for the controlling of the clearance between the bladed turbine rotor and the turbine shroud and the controlling of the clearance between the second bladed turbine rotor and the second turbine shroud.

11. The method of claim 1, wherein the clearance control system is configured to control the clearance between the bladed turbine rotor and the turbine shroud by impinging air against and/or flowing the air along a the turbine casing.

12. The method of claim 11, wherein the measured temperatures are within a threshold range and the clearance control system is configured to cool the turbine casing with the air substantially uniformly around the axis.

13. The method of claim 11, wherein the measured temperatures are outside of a threshold range and the clearance control system is configured to cool the turbine casing with the air asymmetrically around the axis.

14. The method of claim 1, wherein the turbine engine is part of an aircraft propulsion system with a ducted propulsor rotor.

15. The method of claim 1, wherein the turbine engine is part of an aircraft propulsion system with an open propulsor rotor.

16. A method of operating a turbine engine, comprising:
rotating a bladed turbine rotor about an axis, wherein a turbine shroud is next to and circumscribes the bladed turbine rotor; and
controlling a clearance between the bladed turbine rotor and the turbine shroud using a clearance control system, wherein operation of the clearance control system is changed over a period of time to reduce leakage between the bladed turbine rotor and the turbine shroud as at least one of the bladed turbine rotor or the turbine shroud degrades;
wherein the clearance control system is configured to selectively control air flowrates to circumferentially different positions of a turbine casing supporting the turbine shroud based on a comparison of measured temperatures about the turbine casing to a threshold range.

17. The method of claim 16, wherein the operation of the clearance control system is changed over the period of time based on a change in an engine operating parameter over the period of time.

18. The method of claim 16, wherein the clearance control system is further operated to reduce ovalization of a the turbine casing supporting the turbine shroud.

19. A method of operating a turbine engine, comprising:
rotating a bladed turbine rotor about an axis, wherein the bladed turbine rotor comprises a plurality of turbine blades arranged circumferentially about the axis in an array, and a turbine shroud is next to and circumscribes the array of the plurality of turbine blades; and
controlling a clearance between the bladed turbine rotor and the turbine shroud using a clearance control system, wherein operation of the clearance control system is tuned over a period of time to account for at least one of
material worn away from the turbine shroud over the period of time; or
material worn away from the array of the plurality of turbine blades over the period of time;
wherein the clearance control system is configured to selectively control air flowrates to circumferentially different positions of a turbine casing supporting the turbine shroud based on power settings of the turbine engine, wherein each of the power settings corresponds to a different circumferential distribution of air.

20. The method of claim 19, wherein the operation of the clearance control system is tuned over the period of time based on an increase in a combustion products temperature over the period of time compared to a predicted combustion products temperature over the period of time.
